(19) United States
(12) Patent Application Publication
(10) Pub. No.: US 2020/0031649 A1
(43) Pub. Date: Jan. 30, 2020

(54) Device and Method for Filling Liquid or Flowable Contents into Packaging

(71) Applicant: SIG Technology AG, Neuhausen am Rheinfall (CH)

(72) Inventor: Richard Heuser, Herzogenrath (DE)

(21) Appl. No.: 16/478,590

(22) PCT Filed: Jan. 18, 2018
(86) PCT No.: PCT/EP2018/051195

§ 371 Date: Jul. 17, 2019

(30) Foreign Application Priority Data
Feb. 3, 2017 (DE) 10 2017 000 970.8

(51) Int. Cl. B67C 3/12; B67C 3/28

(52) U.S. Cl. CPC B67C 3/12; B67C 3/10; B67C 3/286

(57) ABSTRACT

Shown and described is a device for filling liquid or flowable contents into packaging, comprising: a tank for the contents to be filled; a filling device having a filling valve, wherein the filling valve has a variable flow cross-section and is adjustable between an open position and a fully closed position; a line connecting the tank to the filling device; a throttle valve arranged in the line between the tank and the filling device, wherein the throttle valve has a variable flow cross-section and is adjustable between a first open position and a second open position; and a control device for controlling the filling valve and the throttle valve. In order to optimise the properties of the filling jet, it is proposed that the control device and/or the throttle valve are configured such that the throttle valve is at least partially open throughout the entire filling time. Also shown and described is a method for filling liquid or flowable contents into packaging.

The invention relates to a device for filling liquid or flowable contents into packaging, comprising: a tank for the contents to be filled, a filling device with a filling valve, wherein the filling valve has a variable flow cross-section and is adjustable between an open position and a fully closed position; a line connecting the tank to the filling device; a throttle valve arranged in the line between the tank and the filling device, wherein the throttle valve has a variable flow cross-section and is adjustable between a first open position and a second open position; and a control device for controlling the filling valve and the throttle valve.

The invention also relates to a method for filling liquid or flowable contents into packaging, comprising the following steps: a) providing a device for filling liquid contents into packaging having a filling valve and having a throttle valve, b) opening the filling valve, c) enlarging the flow cross-section of the throttle valve from a first cross-sectional area to a second cross-sectional area, d) reducing the flow cross-section of the throttle valve from a second cross-sectional area to a first cross-sectional area, and e) closing the filling valve.

The filling of liquid contents into packaging is a problem that arises in the field of packaging technology, for example in regard to foodstuffs. There are therefore numerous possibilities known for filling liquid or flowable products into the designated packaging.

The liquid or flowable products may be, for example, foodstuffs such as milk, fruit juice, sauces or yoghurt. As packaging, for example, composite packaging with several thin layers of paper, cardboard, plastic or metal can be used.

The filling is often carried out by a device having a tank for the contents to be filled and a filling device with a filling valve. A line connects the tank to the filling device. Often the tank is located higher than the filling device, so that the line is inclined, and gravity can be used for filling. When the filling valve is opened, contents from the filling device can flow into the packaging until the filling valve is closed again. The filling valve should be completely closable so that a good seal is achieved, and no contents accidentally flow out of the filling device. In particular, for reasons of hygiene, it must be ensured that, when the packaging to be filled is changed, no contents flow out of the filling device and thereby contaminate the filling system.

In addition to the filling valve, further valves are provided in many known devices, such as throttle valves. Throttle valves are used in particular to set and adjust the flow rate. Such a device is known from EP 2 199 249 B1. With regard to the throttle valve, the aforementioned patent proposes that the throttle valve (in the aforementioned patent: “second valve device”) completely interrupts the fluid flow during a filling process at least temporarily.

An important step in the filling of the packaging is to fill the flowable or liquid products as quickly as possible into the packaging in order that fast timing and thus high volumes can be achieved. Despite the high flow rate, however, the filling should be done largely without spattering and foaming in order to meet the hygienic requirements and to avoid contamination on the packaging or the filling machine. Although the method proposed in EP 2 199 249 B1 makes it possible to achieve a clean stall without dripping when closing the filling valve, in practice it has proved disadvantageous for other reasons. This is because the complete shut-off of the throttle valve with the filling valve still open leads to air inclusions in the product stream. This is due, on the one hand, to the fact that the product stream flowing out of the filling device causes a negative pressure in the section between the blocked throttle valve and the open filling valve, which causes air to be drawn into the device through the filling valve. The air flows counter to the flow direction of the product stream and into the device and therefore causes undesirable air inclusions in the product stream. This leads to stalls and to increased formation of splashes when filling the contents in the packaging. The negative pressure also causes air to leach out (“outgassing”) of the contents to be filled (e.g. milk), leading to further air inclusions. Hygienic disadvantages are one consequence of this, for example the contamination of the filling system. The high hygienic requirements, which are to be complied with in particular with the sterile filling of foodstuffs, can hardly be fulfilled in this way.

The invention is therefore based on the problem of redesigning and further developing the aforementioned device previously described in more detail, such that even at high fill rates, a filling is largely possible without splashing and foaming.

This problem is solved by a device according to the preamble of Claim 1 in that the control device and/or the throttle valve are configured such that the throttle valve is at least partially open throughout the entire filling time.

The device is a device for filling liquid or flowable contents into packaging. The liquid or flowable contents may be, for example, foodstuffs such as milk, fruit juice, sauces or yoghurt. As packaging, for example, composite packaging with several thin layers of paper, cardboard, plastic or metal can be used. The device initially comprises a tank for the contents to be filled and a filling device with a filling valve. The tank is preferably arranged at least 10 cm above the filling device. The filling valve has a variable flow cross-section and is adjustable between an open position and a fully closed position. The flow cross-section of the filling valve can thus be reduced to “zero”. The apparatus further comprises a line connecting the tank to the filling device and a throttle valve arranged in the line between the tank and the filling device. The contents to be filled must therefore flow through a throttle valve on their way from the tank to the filling device and to the filling valve. It can be provided that the throttle valve is the only valve between the tank and the filling valve or alternatively that further valves are provided. The throttle valve has a variable flow cross-section and is adjustable between a first open position and a second open position. It can be provided that the throttle valve is not completely closable. The device finally comprises a control device for controlling the filling valve and the throttle valve. For this purpose, the control device is preferably connected to the filling valve and to the throttle valve.

According to the invention, it is provided that the control device and/or the throttle valve are configured such that the throttle valve is at least partially open throughout the entire filling time. The filling time refers to the period in which the liquid contents can exit from the filling valve, i.e. the period between the opening of the filling valve and the closing of the filling valve. According to the invention, no complete shut-off of the throttle valve should take place within this period. The flow cross-section of the throttle valve should therefore be at least partially open during the entire filling time. This can be achieved in different ways:
by adjusting/configuring the control device: the control device should be configured such that the throttle valve is never fully closed at any time during the filling time, although this would be mechanically possible (“control technology solution”);
and/or
by adjusting/configuring the throttle valve: the throttle valve should be configured such that a complete closure of the throttle valve is not mechanically possible, for example due to a passage opening (“mechanical solution”).

One advantage of the throttle valve being at least partially open during the entire filling time is that the pressure surge when opening and closing the filling valve is reduced. This reduces the risk of air inclusions due to air intake and/or outgassing and also reduces the risk of stalls. In addition, the pressure surge can expand against the tank, so that a definable state can be set in the product located in front of the filling valve and exactly the same starting conditions can be set before each filling cycle in the pipe space in front of the filling valve.

It can be provided that the control device and/or the throttle valve are configured such that the throttle valve is at least partially open continuously even outside the filling time.

According to one embodiment of the device, it is provided that the flow cross-section of the throttle valve is at least 3 mm², in particular at least 10 mm² throughout the entire filling time. By establishing a minimum size for the flow-through flow cross-section of the throttle valve, it is also possible to ensure that the throttle valve does not completely interrupt the flow, thus avoiding the associated disadvantages, even in the case of contents to be filled having a high viscosity and/or lumpy constituents (for example fruit pulp). In addition, the outgassing of the contents to be filled can be ruled out.

A development of the device provides a shut-off valve, which is arranged in the line between the tank and the filling device. By providing a shut-off valve in the line in addition to the throttle valve, the filling of the packaging can be controlled even more flexibly. In addition, a stepwise and particularly strong throttling can be achieved by the additional valve without stalling.

For this development, it is further proposed that the control device and/or the shut-off valve are configured such that the shut-off valve is at least partially open throughout the entire filling time. As has already been explained for the throttle valve, according to this further embodiment no complete shut-off of the shut-off valve should take place during the filling time. The flow cross-section of the shut-off valve should therefore be at least partially open during the entire filling time. This can be achieved in different ways:
by adjusting/configuring the control device: the control device should be configured such that the shut-off valve is never fully closed at any time during the filling time, although this would be mechanically possible (“control technology solution”);
   and/or
by adjusting/configuring the shut-off valve: the shut-off valve should be configured such that a complete closing of the shut-off valve is mechanically impossible, for example due to a passage opening (“mechanical solution”).

It can be provided that the control device and/or the shut-off valve are configured in such a way that the shut-off valve is at least partially open continuously even outside the filling time.

According to a development of the device, it is provided that the flow cross-section of the shut-off valve is at least 1 mm², in particular at least 3 mm², throughout the entire filling time. By establishing a minimum size for the flow-through flow cross-section of the shut-off valve, it is also possible to ensure that the shut-off valve does not completely interrupt the flow, thus avoiding the associated disadvantages, even in the case of contents to be filled having a high viscosity and/or lumpy constituents (for example fruit pulp).

The device can be supplemented according to a further embodiment by a flow meter, which is arranged in the line between the tank and the filling device. The flow meter is used to measure the volume flow. The collected data may be used to control the filling valve and other components (e.g. the throttle valve). In particular, the flow meter allows the filling of different filling volumes on the same filling machine. The flow meter may be, for example, a mechanical flow meter, a magnetic-inductive flowmeter, or a mass flow meter (e.g. Coriolis mass flowmeter).

According to a further embodiment of the device, it is provided that the throttle valve and/or the shut-off valve has an actuator for setting the flow cross-section. The actuator serves to vary the valve position and may include, for example, an actuation unit (e.g. pneumatic) and a membrane (e.g. plastic).

For this purpose, it is further proposed that the throttle valve and/or the shut-off valve have a channel whose flow cross-section can be varied by the actuator, in particular can be completely shut off. The variability of the cross-sectional area of the flow cross-section can be achieved, for example, by the fact that the geometry of a channel wall is variable, for example, by a membrane or by another displaceable closure member.

Alternatively or additionally, it can be provided that the throttle valve and/or the shut-off valve have a passage opening whose flow cross-section through the actuator is not variable, in particular cannot be completely shut off. This can be achieved in that the passage opening is arranged outside the range of the movable parts of the actuator. The passage opening can therefore be regarded as a “bypass”, which bridges the areas of the valve that can be shut off.

According to a further embodiment of the device it is provided that the filling valve is segmentless or segmented. A segmentless filling valve is understood to mean a valve which forms only a single filling jet, while a segmented filling valve is understood to mean a valve which divides the filling jet into a plurality of partial flows (e.g. to change the jet shape). For segmentless filling valves, special attention must be paid to a clean start-up and closure (shut off) of the filling jet, which is achieved in a particularly suitable manner by the device described above.

The problem described above is also solved by a method for filling liquid or flowable contents into packaging. The method comprises the following steps: a) providing a device for filling liquid contents into packaging having a filling valve and with a throttle valve, b) opening the filling valve, c) enlarging the flow cross-section of the throttle valve from a first cross-sectional area to a second cross-sectional area, d) reducing the flow cross-section of the throttle valve from a second cross-sectional area to a first cross-sectional area; and e) closing the filling valve.

The method is characterised in that the throttle valve is at least partially open throughout the entire filling time. As has already been described in connection with the device, no complete shut-off of the throttle valve should take place within the filling time. This results in that the contents to be filled can and, if there are no other obstacles, will flow through the throttle valve throughout the entire filling time. The flow cross-section of the throttle valve should therefore be at least partially open during the entire filling time. This can be achieved, for example, in the two manners already described above (“control technology solution”; “mechanical solution”). It can be provided that the control device and/or the throttle valve are configured such that the throttle valve is at least partially open continuously even outside the filling time.

According to one embodiment of the method, it is provided that in step a) a device according to any one of Claims 1 to 10 is provided. By means of the above-described configuration of the control device and/or of the throttle valve, the device described above is suitable in all the illustrated embodiments for carrying out the method in a particular way.

According to a further embodiment the method, it is provided that steps b) to e) take place in the sequence b-c-d-e. It can therefore be provided that initially an opening of the filling valve takes place (step b), before the flow cross-section of the throttle valve increases (step c) and is reduced again (step d). Only then should the filling valve be closed again (step e). In this way, the filling time is divided into several phases with different fill rates: At the beginning of the filling time a low fill rate is used for filling (flow cross-section of the throttle valve small), later an increased fill rate is used for filling (flow cross-section of the throttle valve larger) and in the last phase a filling time is used with a low fill rate for filling again (flow cross-section of the throttle valve small). The reduction of the fill rate at the beginning of the filling time has the advantage that the filling jet starts more effectively and smoothly, and generates less momentum, in particular less foam, in the packaging. The reduction of the fill rate towards the end of the filling time has the advantage that fewer spatters occur.

According to a further embodiment of the method, the method can be supplemented by the following steps: f) enlarging the flow cross-section of the shut-off valve from a first cross-sectional area to a second cross-sectional area, and g) reducing the flow cross-section of the shut-off valve from a second cross-sectional area to a first cross-sectional area, wherein the shut-off valve is at least partially open throughout the entire filling time. As has already been described in connection with the throttle valve, the shut-off valve can also enable changing flow cross-sections and fill rates.

For this purpose, it is further proposed that step f) takes place before steps b) to e). In other words, the opening of the shut-off valve should in particular already take place before the opening of the filling valve. This has the effect that the filling can take place directly when the filling valve opens with the fill rate made possible by the throttle valve. Another advantage is that possibly trapped air bubbles can rise and thus venting is achieved.

Alternatively or additionally, it is finally provided that step g) takes place after step d) and before step e). The flow cross-section of the shut-off valve should therefore be reduced before the filling valve is completely closed again. This results in a reduction in the filling rate in the last phase of the filling time. Another advantage is that a smooth closing and good shut-off of the filling jet is achieved.

The invention will subsequently be explained in more detail with reference to a drawing showing only a preferred design example. In the drawings:

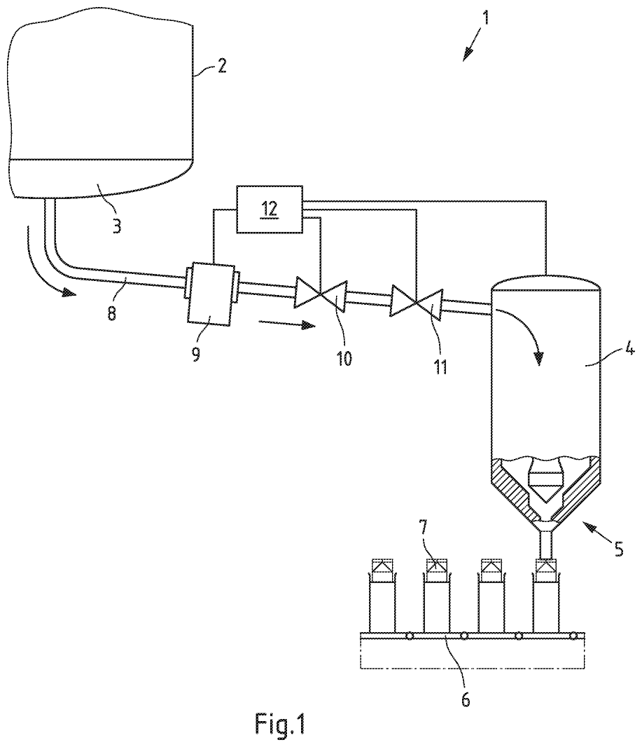

FIG. 1 a first embodiment of a device according to the invention in a schematic view,

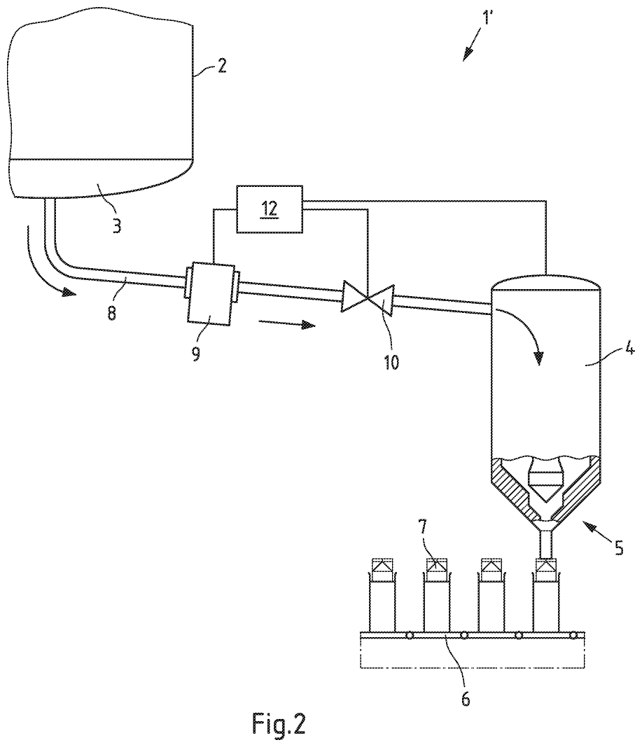

FIG. 2 a second embodiment of a device according to the invention in a schematic view,

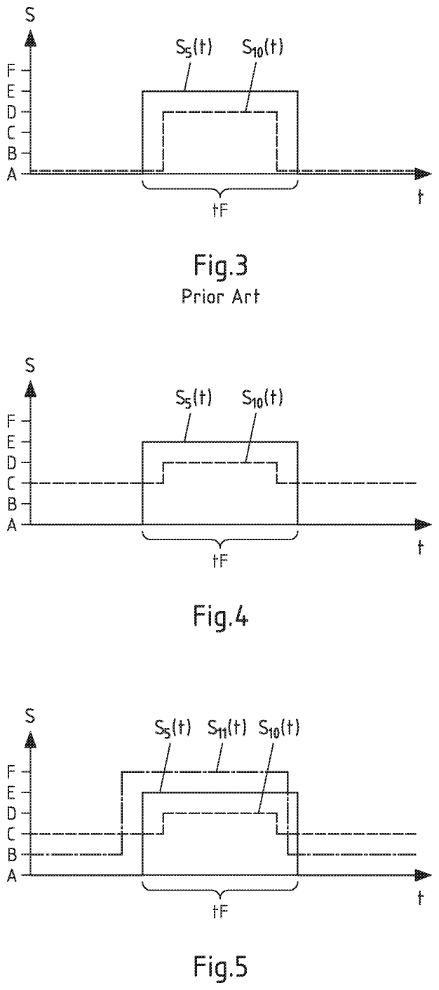

FIG. 3 the time profiles of the valve positions in a method known from the prior art,

FIG. 4 the time profiles of the valve positions in a first embodiment of a method according to the invention,

FIG. 5 the time profiles of the valve positions in a second embodiment of a method according to the invention,

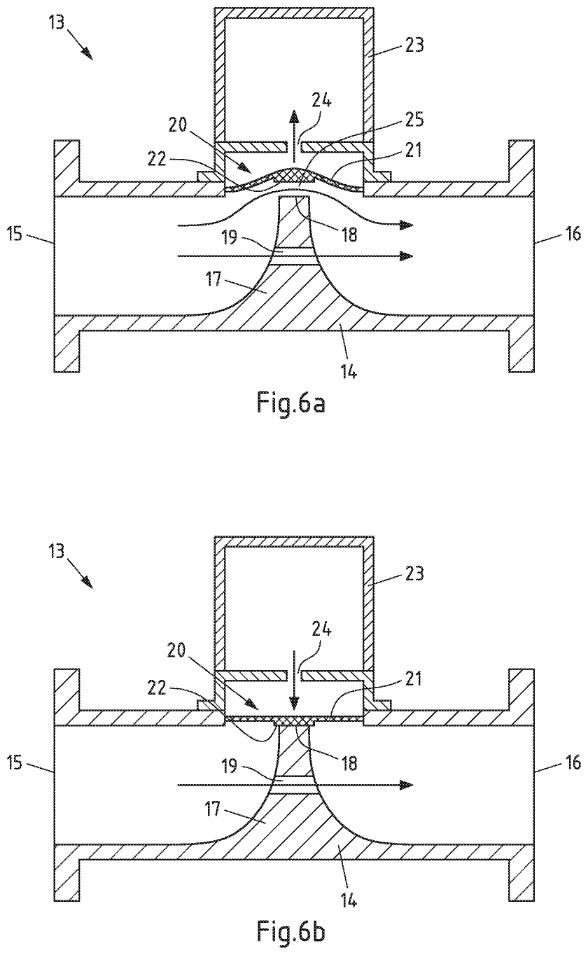

FIG. 6a a valve for a device according to the invention in a first valve position,

FIG. 6b the valve from FIG. 6a in a second valve position, and

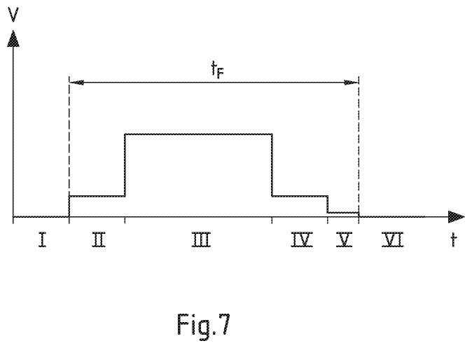

FIG. 7 the time profile of the volume flow.

FIG. 1 shows a first embodiment of a device 1 according to the invention in a schematic view. The device 1 initially comprises a tank 2 for the contents 3 to be filled and a filling device 4 with a filling valve 5. The filling device 4 is arranged above a transport device 6 for packaging 7, so that the contents 3 emerging through the filling valve 5 can be filled approximately vertically into the packaging 7 open at the top. The connection between the tank 2 and the filling device 4 is generated by a line 8 through which the contents 3 can flow (flow direction of the contents 3 in FIG. 1 shown schematically by arrows). The device 1 also comprises a flow meter 9, a throttle valve 10 and a shut-off valve 11, which —viewed in the flow direction—are arranged one after the other in the stated order. In addition, the device 1 has a control device 12. The control device 12 is connected to the flow meter 9, to the throttle valve 10, to the shut-off valve 11 and to the filling device 4 (in particular to its filling valve 5) in the device 1 shown in FIG. 1 and in this respect preferred. The connection can be made by lines or can be wireless.

FIG. 2 shows a schematic view of a second embodiment of a device 1′ according to the invention. Those areas of the device 1′ which have already been described in connection with the device 1 from FIG. 1, are provided in FIG. 2 with corresponding reference numerals. The second embodiment of the device 1′ (FIG. 2) differs from the first embodiment of the device 1 (FIG. 1) in particular in that the shut-off valve 11 has been omitted.

FIG. 3 shows the time profiles of the valve positions in a method known from the prior art. The time t is shown on the first, horizontal axis, wherein the filling time is denoted as t_{F}. On the second, vertical axis the flow cross-section S is shown, wherein the step A corresponds to a completely shut-off flow cross-section S and wherein the steps B to F correspond to differently sized flow cross-section S. In FIG. 3, the profile marked S₁₀(t) corresponds to the flow cross-section S₁₀ of the throttle valve 10 and the profile marked S₅(t) corresponds to the flow cross-section S₅ of the filling valve 5. Both flow cross-sections S₅, S₁₀ are initially completely closed (step A), before the filling valve 5 opens at the beginning of the filling time t_{F} (step E). Following this, the throttle valve 10 opens (step D). Even during the filling time t_{F}, the throttle valve 10 closes completely again (step A). Subsequently, the filling valve 5 closes completely again (step A), whereby the filling time t_{F} is terminated. In the profile shown, the flow cross-section S₁₀ of the throttle valve 10 is thus temporarily closed completely during the filling time t_{F} (at the beginning and at the end of the filling time t_{F}).

The time profiles shown in FIG. 3 correspond approximately to the method known from EP 2 199 249 B1.

In FIG. 4, the time profiles of the valve positions are shown in a first embodiment of a method according to the invention. An essential difference from the profile of the valve positions known from the prior art (FIG. 3) is that in the case of the valve progressions illustrated in FIG. 4, the flow cross-section S₁₀ of the throttle valve 10 is not completely closed at any time during the entire filling time t_{F}. In other words, the flow cross-section S₁₀ of the throttle valve 10 is greater than zero throughout the filling process. It is evident that the filling valve 5 is initially completely closed (step A), while the flow cross-section S₁₀ of the throttle valve 10 is partially open (step C). At the beginning of the filling time t_{F}, the filling valve 5 opens (step E). Following this, the throttle valve 10 increases its flow cross-section S₁₀ (from step C to step D). Even during the filling time t_{F}, the throttle valve 10 again reduces its flow cross-section S₁₀ (from step D to step C), but without completely closing it. Subsequently, the filling valve 5 closes completely again (step A), whereby the filling time t_{F} is ended. The method sequence illustrated in FIG. 4 can be carried out, for example, on a device 1′ shown in FIG. 2.

FIG. 5 shows the time profiles of the valve positions in a second embodiment of a method according to the invention. Also in FIG. 5, the profile indicated by S₁₀(t) corresponds to the throttle valve 10 and the profile marked S₅(t) corresponds to the filling valve 5. In addition, the profile marked S₁₁(t) corresponds to the shut-off valve 11. An essential difference from the profile of the valve positions known from the prior art (FIG. 3) is that in the case of the valve progressions illustrated in FIG. 5, the flow cross-section S₁₀ of the throttle valve 10 is not completely closed at any time throughout the entire filling time t_{F} and the that flow cross-section S₁₁ of the shut-off valve 11 is not completely closed at any time throughout the entire filling time t_{F}. In other words, the contents 3 can flow through the throttle valve 10 and the shut-off valve 11 throughout the filling process. It is evident that the filling valve 5 is initially completely closed (step A), while the flow cross-section S₁₀ of the throttle valve 10 is partially open (step C) and while the flow cross-section S₁₁ of the throttle valve 11 is partially open (step B). Even before the start of the filling time t_{F}, the shut-off valve 11 increases its flow cross-section S₁₁ (from step B to step F). At the beginning of the filling time t_{F}, the filling valve 5 also opens (step E). Following this, the throttle valve 10 increases its flow cross-section S₁₀ (from step C to step D). Even during the filling time t_{F}, the throttle valve 10 again reduces its flow cross-section S₁₀ (from step D to step C), but without completely closing it. Thereafter, and also during the filling time t_{F}, the shut-off valve 11 also reduces its flow cross-section S₁₁ again (from step F to step B). Subsequently, the filling valve 5 closes completely again (step A), whereby the filling time t_{F} is ended. Subsequently, the filling valve 5 closes completely again (step A), whereby the filling time t_{F} is ended. The method sequence illustrated in FIG. 5 can be carried out, for example, on a device 1 shown in FIG. 1.

In FIG. 6a, a valve for a device according to the invention is shown in a first valve position. FIG. 6b shows the valve of FIG. 6a in a second valve position. The valve 13 shown in FIG. 6a and in FIG. 6b can be used, for example, as a throttle valve 10 and/or as a shut-off valve 11. The valve 13 comprises a housing 14 with an inlet 15 and with an outlet 16. The housing 14 has on its inside a projection 17 with a sealing surface 18 and a passage opening 19. On the opposite side of the projection 17, the housing 14 has an opening 20 in which a membrane 21 having a sealing region 22 is arranged. An actuation unit 23 is connected to the opening 20 of the housing 14, which in the valve shown in FIG. 6a and FIG. 6b is a pneumatic actuation unit. In the actuation unit 23, a positive pressure or a negative pressure can be generated, which can act on the membrane 21 through a pressure opening 24.

In the first valve position (FIG. 6a), the sealing region 22 of the membrane 21 is lifted off the sealing surface 18 of the projection 17, which can be achieved by a negative pressure in the actuation unit 23. In the first valve position, the valve 13 can therefore be flowed through in two ways, which are represented by arrows: a partial flow may flow through the passage opening 19 of the projection 17 and a partial flow may flow through a channel 25 which forms between the sealing region 22 of the membrane 21 and the sealing surface 18 of the projection 17. By contrast, in the second valve position (FIG. 6b), the sealing region 22 of the membrane 21 is pressed onto the sealing surface 18 of the projection 17, thereby closing or shutting off the channel 25 (not shown in FIG. 6b). Even in this position, however, a partial flow can flow through the passage opening 19 of the projection 17, so that the valve 13, regardless of the position of the membrane 21, is not completely shut off.

The valve 13 shown in FIG. 6a and in FIG. 6b has a flow cross-section S₁₃ which is composed of the (invariable) flow cross-section S₁₉ of the passage opening 19 and the (variable and blockable) flow cross-section S₂₅ of the channel 25. Due to the passage opening 19, the valve 13 is configured such that the valve 13 is permanently at least partially open, and thus also is open during the entire filling time. The valve 13 shown in FIG. 6a and FIG. 6b represents a structural or mechanical possibility for implementing the invention. Alternatively or additionally, complete shut-off of the flow can be prevented by control technology measures.

In FIG. 7, lastly, the time profile of the volume flow V is shown. For example, this may be the volume flow V through the filling valve 5 of the device 1′ shown in FIG. 2 when the valve positions shown in FIG. 5 are used. The profile of the volume flow V is divided into six time intervals I to VI. The time interval I is before the beginning of the filling time t_{F}. The time intervals II to V together form the filling time t_{F}. The time interval VI is after the end of the filling time t_{F}. The following table shows the valve positions for each of these time intervals:

| Time | Position of the | Position of the | Position of the |
|---|---|---|---|
| interval | shut-off valve 11 | throttle valve 10 | filling valve 5 |
| I | Step F (open, | Step C (open, | Step A (closed) |
| | unthrottled) | throttled) | |
| II | Step F (open, | Step C (open, | Step E (open) |
| | unthrottled) | throttled) | |
| III | Step F (open, | Step D (open, | Step E (open) |
| | unthrottled) | unthrottled) | |
| IV | Step F (open, | Step C (open, | Step E (open) |
| | unthrottled) | throttled) | |
| V | Step B (open, | Step C (open, | Step E (open) |
| | throttled) | throttled) | |
| VI | Step B (open, | Step C (open, | Step A (closed) |
| | throttled) | throttled) | |

### LIST OF REFERENCE NUMERALS

1, 1′: Device for filling liquid contents
2: Tank
3: Content
4: Filling device
5: Filling valve
6: Transport device
7: Packaging
8: Line
9: Flow meter
10: Throttle valve
11: Shut-off valve
12: Control device
13: Valve
14: Housing
15: Inlet
16: Outlet
17: Projection
18: Sealing surface
19: Passage opening
20: Opening
21: Membrane
22: Sealing region (of the membrane 22)
23: Actuation unit
24: Pressure opening
25: Channel
t: Time
t_{F}: Filling time
A-F: Steps (of the valve position)
S: Flow cross-section
S₅: Flow cross-section (of the filling valve 5)
S₁₀: Flow cross-section (of the throttle valve 10)
S₁₁: Flow cross-section (of the throttle valve 11)
S₁₃: Flow cross-section (of the valve 13)
S₁₉: Flow cross-section (of the passage opening 19)
S₂₅: Flow cross-section (of the channel 25)
S₅(t): Time profile of the flow cross-section (of the filling valve 5)
S₁₀(t): Time profile of the flow cross-section (of the throttle valve 10)
S₁₁(t): Time profile of the flow cross-section (of the shut-off valve 11)
V: Volume flow
I-IV: Time interval

1. A device for filling liquid or flowable contents into packaging, comprising:
a tank for the contents to be filled,
a filling device with a filling valve,
wherein the filling valve has a variable flow cross-section and is adjustable between an open position and a fully closed position;
wherein the filling time refers to the period between the opening of the filling valve and the closing of the filling valve,
a line connecting the tank to the filling device;
a throttle valve arranged in the line between the tank and the filling device,
a shut-off valve being arranged in the line between the lank and the filling device,
wherein the throttle valve has a variable flow cross-section and is adjustable between a first open position and a second open position; and
a control device for controlling the filling valve, the throttle valve, and the shut-off valve,
characterised in that
the control device and/or the throttle valve are configured such that the throttle valve is at least partially open throughout the entire filling time
and that
the control device and/or the shut-off valve are configured such that the shut-off valve is at least partially open throughout the entire filling time.

2. The device according to claim 1,
wherein
the flow cross-section of the throttle valve is at least 3 mm², in particular at least 10 mm², throughout the entire filling time.

3. (canceled)

4. (canceled)

5. The device according to claim 1,
wherein
the flow cross-section of the shut-off valve is at least 1 mm², in particular at least 3 mm², throughout the entire filling time.

6. The device according to claim 1,
wherein
a flow meter is arranged in the line between the tank and the filling device.

7. The device according to claim 1,
wherein
the throttle valve and/or the shut-off valve has an actuator for adjusting the flow cross-section.

8. The device according to claim 7,
wherein
the throttle valve and/or the shut-off valve have a channel, whose flow cross-section can be varied by the actuator, in particular completely shut off.

9. The device according to claim 7,
wherein
the throttle valve and/or the shut-off valve have a passage opening, whose flow cross-section cannot be varied by the actuator, in particular cannot be completely shut off.

10. The device according to claim 1,
wherein
the filling valve is segmentless or segmented.

11. A method for filling liquid or flowable contents into packaging, comprising the following steps:
a) providing a device for filling liquid contents into packaging with a filling valve, a throttle valve, and a shut-off valve,
b) opening the filling valve
c) increasing the flow cross-section of the throttle valve from a first cross-sectional area to a second cross-sectional area,
d) reducing the flow cross-section of the throttle valve from a second cross-sectional area to a first cross-sectional area,
e) closing the filling valve,
f) increasing the flow cross-section of the shut-off valve from a first cross-sectional area to a second cross-sectional area, and
g) reducing the flow cross-section of the shut-off valve from a second cross-sectional area to a first cross-sectional area,
wherein the filling time refers to the period between the opening of the filling valve and the closing of the filling valve, and wherein the throttle valve is at least partially open throughout the entire filling time,
wherein
the shut-off valve is at least partially open throughout the entire filling time.

12. (canceled)

13. The method according to claim 12,
wherein
the steps b) to e) take place in the sequence b-c-d-e.

14. (canceled)

15. The method according to claim 11,
wherein
step f) takes place before steps b) to e).

16. The method according to claim 11,
wherein
step g) takes place after step d) and before step e).
